(19) United States
(12) Patent Application Publication
(10) Pub. No.: US 2008/0230562 A1
(43) Pub. Date: Sep. 25, 2008

(54) Bulk feeding system and method

(75) Inventors: Richard T. Price, Lehi, UT (US); Byron D. Larson, South Jordan, UT (US)

Correspondence Address: DAVID R. MCKINNEY, P.C., P.O. BOX 1460, SANDY, UT, 84091, US

(73) Assignee: MULTI-FILL, INC.

(21) Appl. No.: 11/726,400

(22) Filed: Mar. 21, 2007

(51) Int. Cl. B67D 5/40; B23Q 7/00

(52) U.S. Cl. 222/372

(57) ABSTRACT

A bulk product feeding system includes a product hopper, and a reciprocating ram, positioned in the bottom of the hopper. The hopper has substantially vertical sidewalls, and the ram has a width substantially equal to the width of the hopper. The hopper is configured to hold a bulk quantity of sticky or fragile product, and the sidewalls are spaced apart a distance sufficient to resist bridging of the product. The ram is configured to selectively extend to push product out of an outlet of the hopper, and to retract to allow product to drop down to the bottom of the hopper.

### BACKGROUND

1. Field of the Invention

The present invention relates generally to equipment for handling food products and other fragile bulk products.

2. Related Art

In food packaging operations, bulk products such as cooked noodles, rice, etc. are frequently transported from the cooking facilities to the packaging facilities via a large container (e.g. 300 liter “bucket”) and dumped into the inlet of a portioning and packaging machine. This machine divides the bulk product into individual portions and places the portions into packages. This sort of operation is widely used for packaging TV dinners and the like.

Many mechanical bulk product portioning and packaging machines cannot receive large quantities of the product all at once, especially where the product is sticky or fragile. This is because of the nature of the products and of bulk product transporting machines. Bulk product transport machines generally include a large tapered hopper into which the product is dumped, with a transport mechanism such as a conveyor or auger at the bottom, to which all product is directed, and which draws the product at some desired rate out of the hopper.

Unfortunately, sticky products tend to bridge across the narrow neck of the hopper, causing the auger or conveyor to “tunnel” through the bottom of the product, thus stopping the flow. This sort of condition requires constant worker attention, which increases the cost of packaging and handling the product. Augers and similar devices can also be damaging to fragile products, and can be dangerous to operators.

### SUMMARY

It has been recognized that it would be advantageous to develop a product dispensing system that can receive product in relatively large quantities at spaced apart intervals, and dispense the product at a much lower controlled rate.

It has also been recognized that it would be advantageous to have a product dispensing system that is resistant to bridging and clogging of product within a product hopper.

It has also been recognized that it would be advantageous to have a product dispensing system that is gentle to fragile products, such as food products.

In accordance with one embodiment thereof, the present invention provides a bulk product feeding system, including a product hopper, having a bottom, and a ram, positioned in the bottom of the hopper. The hopper has a front end, substantially vertical sidewalls defining a width, and an outlet located at the bottom of the front end. The hopper is configured to receive and hold a bulk quantity of sticky or fragile product, the sidewalls being spaced apart by a distance sufficient to resist bridging of the product. The ram has a width substantially equal to the width of the hopper, and is configured to selectively extend to push product out of the outlet, and to retract to allow product to drop down to the bottom of the hopper.

In accordance with another aspect thereof, the invention provides a product packaging system, including a bulk feeder, and a product measuring and dispensing apparatus. The bulk feeder includes a product hopper with a bottom, and a ram, positioned in the bottom of the hopper. The hopper includes a front end, substantially vertical sidewalls defining a width, and an outlet located at the bottom of the front end, configured to receive and hold a bulk quantity of sticky or fragile product. The sidewalls of the hopper are spaced apart a distance sufficient to resist bridging of the product. The ram has a width substantially equal to the width of the hopper, and is configured to selectively extend to push product out of the outlet, and to retract to allow product to drop down to the bottom of the hopper. The product measuring and dispensing apparatus includes an inlet, positioned to receive the product dispensed from the bulk feeder, and to dispense measured quantities of the product into containers.

In accordance with yet another aspect thereof, the invention provides a method for controllably dispensing a bulk product. The method includes the steps of placing a bulk quantity of the product into a hopper having substantially vertical sidewalls defining a width sufficient to resist bridging of the product, a bottom, a front end, and an outlet located the bottom at the front end, and dispensing a controlled quantity out of the outlet of the hopper with a reciprocal ram positioned in the bottom of the hopper.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a top rear perspective view of one embodiment of a bulk feeding hopper with a reciprocal ram in accordance with the present disclosure;

FIG. 2 is a front perspective view of the bulk feeding hopper of FIG. 1

FIG. 3 is a side, cross-sectional view of one embodiment of a bulk feeding system having a hopper and ram like that of FIG. 1, showing the ram in the retraction phase;

FIG. 4 is a side, cross-sectional view of the embodiment of FIG. 3, showing the ram in the extension phase;

FIG. 5 is an illustration of one embodiment of a product packaging system incorporating a bulk feeding system in accordance with the present disclosure;

FIG. 6 is an illustration of another embodiment of a product packaging system incorporating a bulk feeding system in accordance with the present disclosure;

FIG. 7 is a side, cross-sectional view of an embodiment of a bulk feeding system like that of FIG. 3, having directionally pivoting product-loosening fingers attached to the ram, showing the ram in the retraction phase;

FIG. 8 is a side, cross-sectional view of the embodiment of FIG. 7, showing the ram in the extension phase; and

FIG. 9 is a side, cross-sectional view of an alternative embodiment of a bulk feeding system in accordance with the present disclosure.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

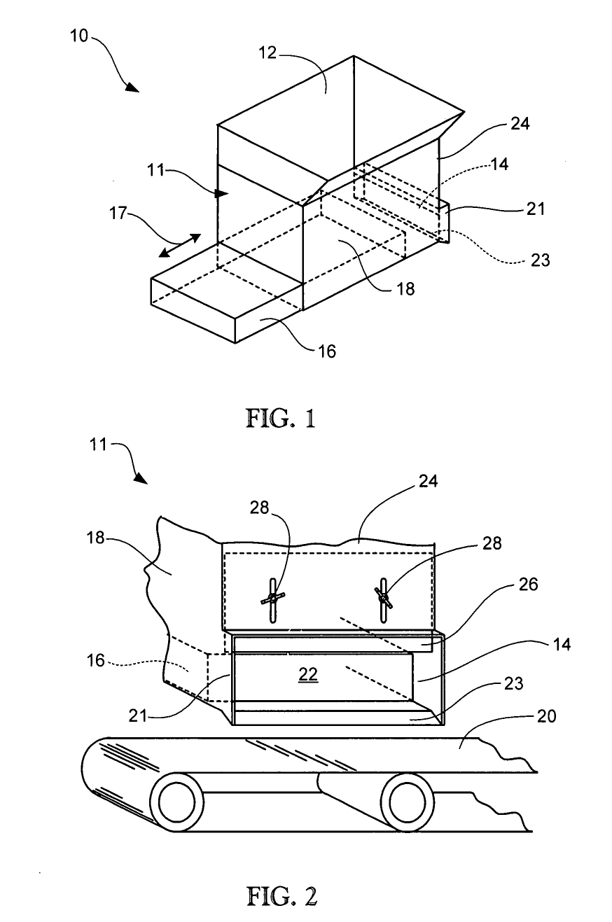

The inventors have developed a bulk feeding system that allows sticky or fragile products, such as food products, to be loaded in bulk into a feed hopper for a product packaging system, and which avoids or reduces some problems, such as tunneling and damage to the product, that are common with augers or conveyors and other bulk product transport devices. One embodiment of a bulk feeding system 10 is shown in FIGS. 1 and 2. The system generally includes a bulk feed hopper 1 having an inlet 12, an outlet opening 14, and a reciprocating ram 16 that slides back and forth in the bottom of the hopper, as indicated by arrow 17. The hopper has vertical sidewalls 18 and is made wide enough so that the product cannot bridge between the sides. The ram is as wide as the hopper, and has a cross-sectional shape that is similar to the size and shape of the outlet opening. The size and shape of the hopper, the ram, and other components of the bulk feeding system can vary. In one embodiment, the hopper is approximately 4 ft high, 2 ft long and 1.5 ft wide, and holds a volume of about 90 gallons. To effectively prevent product from bridging in the bottom of the hopper, the width of the hopper can range from as small as about 6 inches wide, though more practically about 1 foot wide to about 4 feet wide or more.

In use, bulk product 30 is dumped into the inlet 12 of the hopper 11 in large batches, and is pushed out of the outlet 14 opening by the ram 16 at a controlled rate. When the ram retracts (i.e. pulls partially out of the hopper), the bulk product falls down into the bottom of the hopper. When the ram is extended forward, product is pushed out of the outlet. The top surface of the ram is flat and smooth so that the ram can slide beneath the product in the hopper during its extension phase, and so that product cannot become trapped behind the ram during the retraction phase. The ram can vary from about ½ inch high to about 6 inches high, depending upon the product flow and desired feed rate. Where food products are to be dispensed, the bulk feeder (e.g. the hopper, ram, etc.) can be made of food grade acceptable stainless steels and plastics.

A view of the forward end of the hopper 11 and ram 16 is shown in FIG. 2. The outlet 14 of the hopper can be located adjacent to a product conveyor 20 onto which product falls as it is discharged from the hopper. A projecting shroud 21 can be provided around the sides and top of the outlet, and this can interconnect with a ramp 23 that extends downwardly from the bottom edge of the outlet toward the conveyor, to guide the product as it discharges. As shown in FIG. 2, this conveyor can be oriented substantially perpendicular to the direction of motion of the ram, but this is not required.

The outlet 14 can include an adjustable choke plate 26 that can be raised or lowered within the outlet opening and secured at a desired elevation (e.g. via wing nuts 28) to allow the size of the outlet opening to be adjusted. The outlet opening can vary from approximately the same height as the ram 16, up to about 6 times the height of the ram. In addition, a given bulk feeding system can be provided with multiple rams of different heights, allowing a user to interchange the ram at will to use a different ram for a different product, with the height of the outlet adjusted accordingly. The size of the outlet opening and how much clearance is provided around the forward face of the ram at maximum extension are factors that can vary depending upon the nature of the product being discharged. Typically, the outlet of the hopper is slightly higher than the ram, so that if the ram is fully extended (i.e. extended so that the forward face 22 of the ram becomes substantially aligned with the forward wall 24 of the hopper) any product that might be hanging in the outlet opening will not be cut off.

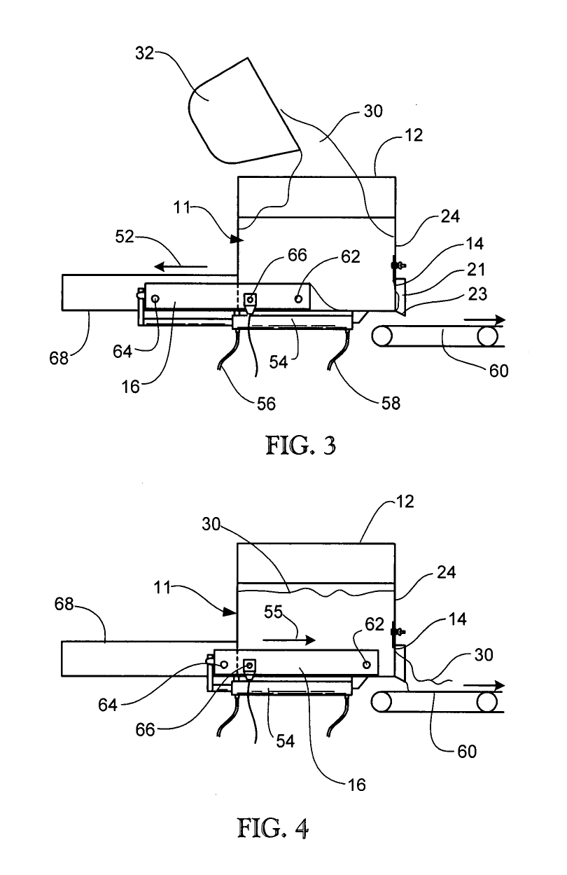

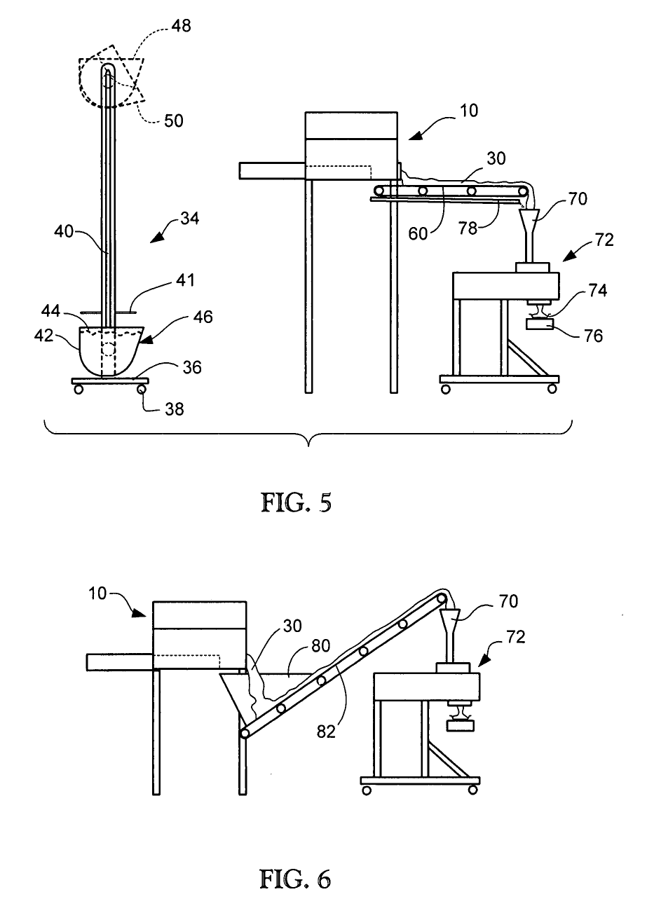

Side, cross-sectional views of one embodiment of a bulk feeding system 10 having a hopper and ram like that of FIG. 1 are provided in FIGS. 3 and 4. In typical use, a relatively large quantity of product 30 is dumped into the inlet 12 of the hopper 11 from come sort of conveyance container 32. The conveyance container can be part of a bin hoist, for example. Bin hoists are frequently used in the food packaging industry for transporting batches of food product from a kitchen to the product packaging area. One type of bin hoist 34 is shown in FIG. 5. The bin hoist includes a base 36 having wheels or casters 38, with a vertical mast 40 attached to the base. A handle 41 is attached to the mast to allow a user to roll the hoist to a desired location. A bin 42 for containing bulk product 44 (shown in dashed lines) is attached to the mast, and can be moved from a lower position, shown at 46, to a raised position (shown in dashed lines at 48). The bin is usually held at the lower position when it is desired to move the bin hoist to another location. When at the desired location, the bin is hoisted up the mast (e.g. via a hand crank or via a power winch mechanism) to the raised position, at which the bin can be rotated, as shown at 50, to allow the user to dump the product.

Referring back to FIG. 3, when the product 30 is dumped into the inlet 12 of the hopper 10, the ram 16 is initially retracted, in the direction of arrow 52, to allow the product to fall to the bottom of the hopper. The ram can be powered in a variety of ways. In the embodiment depicted in FIGS. 3 and 4, the ram is powered by a bidirectional pneumatic cylinder 54 that can cause the ram to retract in the direction of arrow 52 in FIG. 3, or extend in the direction of arrow 55 in FIG. 4. When the ram is retracted, product falls to the bottom of the hopper, as shown in FIG. 3. When the ram extends, product is forced out of the outlet 14 and onto a conveyor 60 or other product receiving device. This allows the product to be loaded into the hopper in large batches (which may not be uniform in volume), and discharged from the bulk feeding system at a lower, controlled rate.

Compressed air is provided to the pneumatic cylinder via air lines 56, 58. A system controller (not shown) can control the compressed air that is provided to the pneumatic cylinder (and control valves, etc.) to allow the direction, speed, and other aspects of the motion of the ram 16 to be very accurately controlled. For example, the ram can be caused to extend or retract with a pulsatile motion, having very long or very short dwell times between pulses. Pulsatile motion can be desirable for inducing vibration into the product to prevent sticking, encourage loosening, etc. A wide variety of other motions can also be provided.

The system shown in FIGS. 3 and 4 includes a mechanism for sensing the motion of the ram 16. Such a system can be configured in many ways. In this system the side walls of the ram include holes 62 near the forward end of the ram, and holes 64 near the rear end of the ram. An optical sensor 66 is attached to one side wall of the hopper, and is aimed at a corresponding target or reflector (not shown) positioned on the inside of the opposite wall of the hopper. When the ram retracts to a position in which the optical sensor 66 is aligned with the forward holes 62, a circuit will be completed in the sensor, which will send a signal to the controller that the ram is fully retracted. Conversely, when the ram extends to a position in which the optical sensor is aligned with the rearward holes 64, the same circuit will also be completed in the sensor, and, because the direction of motion of the ram is known, this will send a signal to the controller that the ram is fully extended. This sensing system thus detects the extreme positions of the ram, allowing the direction of the ram to be reversed at the appropriate time. It is to be understood, however, that other and more sophisticated sensing systems can be used to detect the position and motion of the ram.

A ram cover 68 can also be provided to encase the ram and cover at least some of the moving parts associated with it. This cover can also help to protect the ram from damage and from contact with foreign materials. For example, since the ram comes into direct contact with the product that is dispensed from the hopper 10, it can be desirable to protect the ram from dirt or debris that might contaminate a food product.

Two exemplary installations of bulk feeding systems 10 are shown in FIGS. 5 and 6. In FIG. 6, the bulk feeding system is elevated and positioned to discharge product onto a horizontal conveyor 60. This conveyor in turn feeds the product into an inlet 70 of a product portioning machine 72 that dispenses measured portions of product into containers 74 on a conveyor 76. Alternatively, the conveyor could transport the product to a multipathway product distribution system that directs the product to multiple product portioning machines. The use of a horizontal conveyor can be desirable where the product includes liquid that it is desirable to retain. For example, some food products include sauce or broth that can tend to drip away during packaging. With the horizontal conveyor 60 shown in FIG. 5, liquids are generally retained. Additionally, a drip trough 78 can be positioned below the conveyor to catch liquids that might drip from the conveyor. The drip trough can be sloped to cause the liquids to drain into the inlet of the product portioning machine.

As an alternative to the horizontal conveyor 60 shown in FIG. 5, a bulk feeding system configured as described herein can be positioned to discharge product into an inlet hopper 80 of a sloped product conveyor 82 that feeds into an inlet 70 of a product portioning machine 72. With this configuration the bulk feeding machine is not required to be positioned quite as high. However, in both cases a bin hoist is likely to be used to lift and dump the product into the inlet of the bulk feeding system.

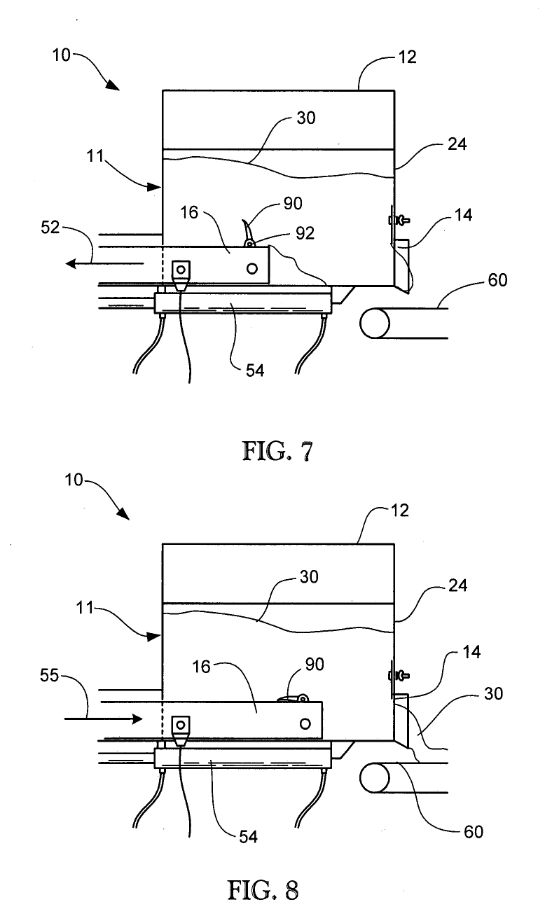

The bulk feeding system 10 can also include a product separator device that helps to break up and loosen product as the ram retracts. Some bulk products, especially sticky food products such as cooked noodles, rice, etc., can tend to stick or clump together, especially when located near the bottom of a hopper filled with the product. The inventors have found that the motion of the bulk feeding ram can be used to help break up and loosen the product so that it will be easier to discharge from the bulk feeding system. One embodiment of a product separator device is shown in FIGS. 7 and 8. In this embodiment, a rake 90 is pivotally attached to the forward end of the ram 16 at a pivot mount 92. The view provided in FIGS. 7 and 8 is a side view, and does not show the teeth of the rake. However, it is to be appreciated that the rake includes a plurality of teeth or tines that are relatively rigid and are separated from each other by some uniform spacing. The length and spacing of the rake tines can vary depending upon the product that is to be separated. The teeth or tines can be relatively blunt, so as to be gentle to the product, though the degree of bluntness or sharpness can also vary depending upon the product.

The pivot mount 92 can be provided with a stop (not shown) so that the rake 90 will pivot between an approximately upright position, shown in FIG. 7, with the teeth of the rake pointed upwardly, and a substantially horizontal position, lying substantially flat against the top of the ram, as shown in FIG. 8. With this configuration, rearward motion of the ram 16, in the direction of arrow 52, during the retraction phase shown in FIG. 7 will cause the rake to stand up and rake through the underside of the product. This will help loosen the product and allow it to more readily fall down into the bottom of the hopper 11. However, during extension of the ram, as shown in FIG. 8, the rake will naturally drop down against the top of the ram when the ram moves in the direction of arrow 55, and will not rake through the product.

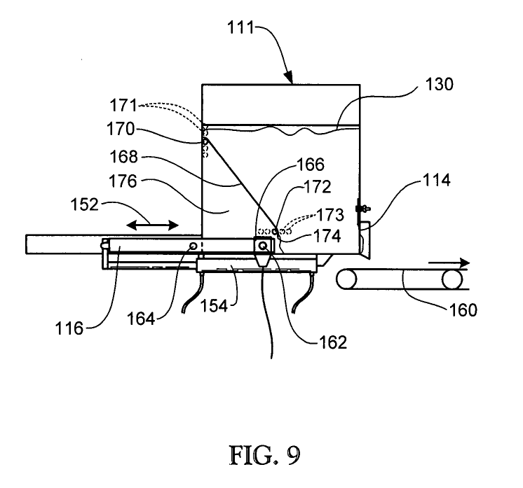

A cross-sectional view of another embodiment of a bulk feeding system is shown in FIG. 9. In this embodiment the proportions of the hopper 111 and ram 116 are varied, such that the hopper is taller and the ram is shorter (thinner) than other embodiments depicted previously. The ram reciprocates in the direction of arrow 152 under the power of the actuator 154 (e.g. a pneumatic cylinder) to push the product 130 through the outlet 114 and onto the conveyor 160. In this embodiment, the hopper is provided with an adjustable baffle 168 that slopes down toward the outlet. The baffle is supported within the hopper by an upper support pin or bolt 170 and a lower support pin or bolt 172, and has a lower edge 174 that defines a rear opening through which the ram extends and retracts as it reciprocates. Because of the position of the baffle, there is a space 176 behind the baffle into which product does not enter when dumped into the hopper. The height of the rear opening can be just slightly higher than the ram, in order to reduce any quantity of product that might be drawn into the space behind the baffle by the reciprocating motion of the ram. The configuration of the baffle reduces the amount of product that presses upon the top of the ram, and thus reduces the pressure that is imposed upon the ram, making it easier to move the ram. This can be desirable with some products. While the baffle also tends to reduce the useable volume of the hopper, this can be taken into account when designing a hopper for a given type of product.

The upper and lower support pins 1 70, 172 can be selectively positionable within a series of mounting holes 171, 173, respectively. This allows the positions of the support pins to be adjusted so that the position and slope of the baffle can vary. The desired position and slope of the baffle within the hopper 11I can vary depending upon the nature of the product that is to be dispensed with the bulk-feeding system. It will be apparent that other methods for adjustably attaching a baffle or comparable device within the hopper can be used, as can other systems for selectively adjusting the internal geometry and volume of the hopper. It should also be noted that a fixed baffle can be disposed in the hopper, as an alternative to an adjustable one. A fixed baffle can have the effect of structurally stiffening the hopper, though it does not have the flexibility of use of the adjustable baffle.

In the embodiment depicted in FIG. 9, the stroke length of the ram 116 will be shorter than the length of the hopper 111. Consequently, the ram can be provided with sensor holes 162 and 164 that are closer together than in other embodiments, with an optical sensor device 166 positioned to detect when the ram is fully extended and when it is retracted past the rear opening below the baffle 168. It will be apparent that the ram can be provided with multiple sensor holes that can be covered or left open, as desired, to allow the stroke length of the ram to be adjusted among a range of lengths.

The invention thus provides a system that dispenses bulk products that may be sticky and/or fragile (e.g. not suitable for auger or direct conveyor withdrawal), and also allows the input of large quantities, while dispensing small quantities at a controlled rate. In various embodiments produced and tested by the inventors, the feeder can deliver product at a rate of more than 1,000 gallons per hour or 4,000 lbs. per hour, depending upon the nature of the product. The configuration of the hopper and ram prevents bridging and sticking of the product, thus allowing large quantities to be placed into the hopper while not requiring worker attention to prevent clogs, etc. Additionally, controlling the rate of extension of the ram allows control of the rate of dispensing of the product out of the bulk feeding system.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A bulk product feeding system, comprising:
a product hopper, having a bottom, a front end, substantially vertical sidewalls defining a width, and an outlet located at the bottom of the front end, configured to receive and hold a bulk quantity of sticky or fragile product, the sidewalls being spaced apart by a distance sufficient to resist bridging of the product; and
a ram, positioned in the bottom of the hopper and having a width substantially equal to the width of the hopper, configured to selectively extend to push product out of the outlet, and to retract to allow product to drop down to the bottom of the hopper.

2. A bulk product feeding system in accordance with claim 1, wherein the hopper has a width of from about 1 foot to about 4 feet.

3. A bulk product feeding system in accordance with claim 1, wherein the ram is actuated by a bidirectional actuator, and is capable of extending or retracting with a pulsatile motion.

4. A bulk product feeding system in accordance with claim 1, further comprising a baffle, disposed within the hopper, extending downward from a rear of the hopper toward the outlet to a position near a top of the ram, thereby to reduce an area of contact of product upon the top of the ram.

5. A bulk product feeding system in accordance with claim 4, further comprising an adjustable choke plate, moveably disposed at a top of the outlet, whereby the height of the outlet opening can be selectively adjusted.

6. A bulk product feeding system in accordance with claim 1, further comprising a motion sensor, associated with the ram and the hopper, configured to detect at least a maximum forwardly extended position of the ram, and a maximum rearwardly retracted position of the ram.

7. A bulk product feeding system in accordance with claim 1, further comprising a rake, having teeth, pivotally attached to a forward end of a top of the ram, configured to extend upwardly into the product during retraction of the ram, thereby to loosen the product with the teeth, and to retract toward the top of the ram during extension of the ram.

8. A bulk product feeding system in accordance with claim 1, wherein the hopper is configured to hold approximately 90 gallons of product, and the cross-sectional size and shape of the ram, the size of the outlet, and the extension speed of the ram are selected to dispense product thorough the outlet at a rate of from 0 to about 1,000 gallons per hour.

9. A product packaging system, comprising:
a bulk feeder, having
a product hopper with a bottom, a front end, substantially vertical sidewalls defining a width, and an outlet located at the bottom of the front end, configured to receive and hold a bulk quantity of sticky or fragile product, the sidewalls being spaced apart by a distance sufficient to resist bridging of the product, and
a ram, positioned in the bottom of the hopper and having a width substantially equal to the width of the hopper, configured to selectively extend to push product out of the outlet, and to retract to allow product to drop down to the bottom of the hopper; and
a product measuring and dispensing apparatus, having an inlet, positioned to receive the product dispensed from the bulk feeder, and to dispense measured quantities of the product into containers.

10. A product packaging system in accordance with claim 9, further comprising a baffle, disposed within the hopper, extending downward from a rear of the hopper toward the outlet to a position near a top of the ram, thereby to reduce an area of contact of product upon the top of the ram.

11. A product packaging system in accordance with claim 9, wherein the hopper has a width of from about 1 foot to about 4 feet.

12. A product packaging system in accordance with claim 9, further comprising a motion sensor, associated with the ram and the hopper, configured to detect at least a maximum forwardly extended position of the ram, and a maximum rearwardly retracted position of the ram.

13. A product packaging system in accordance with claim 9, further comprising an adjustable choke plate, moveably disposed at a top of the outlet, whereby the height of the outlet opening can be selectively adjusted.

14. A product packaging system in accordance with claim 9, further comprising a rake, having teeth, pivotally attached to a forward end of a top of the ram, configured to extend upwardly into the product during retraction of the ram, thereby to loosen the product with the teeth, and to retract toward the top of the ram during extension of the ram.

15. A method for controllably dispensing a bulk product, comprising the steps of:
placing a bulk quantity of the product into a hopper having substantially vertical sidewalls defining a width sufficient to resist bridging of the product, a bottom, a front end, and an outlet located the bottom at the front end; and
dispensing a controlled quantity out of the outlet of the hopper with a reciprocal ram positioned in the bottom of the hopper.

16. A method in accordance with claim 15, wherein the step of dispensing a controlled quantity out of the outlet of the hopper further comprises extending the ram toward the outlet to push the product out of the outlet, and retracting the ram away from the outlet to allow product to drop into the bottom of the hopper.

17. A method in accordance with claim 16, further comprising the step of extending a product separator device attached to the ram into the product during retraction of the ram, thereby to loosen the product in the hopper as the ram retracts.

18. A method in accordance with claim 15, wherein the step of placing a bulk quantity of the product into the hopper comprises dumping up to about 90 gallons of product into the hopper, and the step of dispensing a controlled quantity out of the outlet of the hopper comprises pushing product thorough the outlet at a rate of from 0 to about 1,000 gallons per hour.

19. A method in accordance with claim 15, further comprising the steps of:
placing the product dispensed from the outlet into an inlet of a product measuring and dispensing machine; and
dispensing measured quantities of the product into product containers.

20. A method in accordance with claim 15, further comprising the step of detecting at least a maximum forwardly extended position of the ram, and a maximum rearwardly retracted position of the ram.
